(19) United States
(12) Patent Application Publication
(10) Pub. No.: US 2010/0233560 A1
(43) Pub. Date: Sep. 16, 2010

(54) FUEL CELL SYSTEM

(75) Inventor: Shigeto Kajiwara, Okazaki-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/738,269

(22) PCT Filed: Oct. 6, 2008
(86) PCT No.: PCT/JP2008/068188

§ 371 Date: Apr. 15, 2010

(30) Foreign Application Priority Data
Oct. 16, 2007 (JP) 2007-268770

(51) Int. Cl. H01M 8/04

(52) U.S. Cl. 429/434; 429/428

(57) ABSTRACT

To quickly and optimally control the water condition and temperature of a fuel cell even when the fuel cell is at a low temperature and in a dry state. If it is determined that a fuel cell is in a dry state and is determined that the fuel cell is at a low temperature, a control device performs low-efficiency power generation. Performing the low-efficiency power generation makes it possible to quickly warm up the fuel cell and bring the cathode water balance of a fuel cell into a plus (wet) state, so that the water condition and temperature of the fuel cell can be quickly and optimally controlled.

### TECHNICAL FIELD

The present invention relates to a fuel cell system.

### BACKGROUND ART

In a fuel cell system, a solid polymer type fuel cell is mounted in which a solid polymer membrane having a proton conductivity is applied to an electrolyte layer. The solid polymer membrane of this fuel cell indicates a high proton conductivity in a wet state, whereby it is important to keep the solid polymer membrane in the wet state so that a power is efficiently generated.

In view of such a situation, there is suggested a method of executing processing (hereinafter referred to as the FC temperature lowering processing) for lowering the temperature of the fuel cell in a case where the water condition of the fuel cell is diagnosed based on the open circuit voltage of the fuel cell and it is diagnosed that the fuel cell has a dry state (e.g., see Patent Document 1). Here, low temperature air has a smaller amount of water carried away as compared with high temperature air. Therefore, when the temperature of the fuel cell is lowered as described above, the temperature of the air discharged from the fuel cell also lowers, and the water of the dry fuel cell can be controlled into an optimum state.
Patent Document 1: Japanese Patent Application Laid-Open No. 2005-32587

### DISCLOSURE OF THE INVENTION

### Problem to be Solved by the Invention

However, when a fuel cell is at a low temperature (e.g., during low temperature start or the like) and the fuel cell is in a dry state, it is necessary to perform processing (hereinafter referred to as warm-up processing) of once further lowering the temperature of the fuel cell to bring the water of the fuel cell into an optimum state and then warming up the fuel cell to bring the temperature of the fuel cell close to a target temperature. Thus, in a conventional technology, when the fuel cell is at the low temperature and the fuel cell is in the dry state, it is necessary to execute laborious processing such as FC temperature lowering processing→warm-up processing, and there has been a problem that it is difficult to meet a demand for the speedup of the processing.

The present invention has been developed in view of the above-mentioned situation, and an object thereof is to provide a fuel cell system capable of quickly and optimally controlling the water condition and temperature of a fuel cell even when the fuel cell is at a low temperature and in a dry state.

### Means for Solving the Problem

To achieve the above object, a fuel cell system of the present invention is characterized by including: first judgment means for judging whether or not a fuel cell is in a dry state; second judgment means for judging whether or not to allow low-efficiency power generation in which the amount of a reactant gas to be supplied to the fuel cell is small as compared with usual power generation and in which a power loss is large as compared with the usual power generation, in a case where it is judged that the fuel cell is in the dry state; and power generation control means for executing the low-efficiency power generation in a case where it is judged that the low-efficiency power generation is allowed.

According to such a constitution, in a case where it is judged that the fuel cell is in the dry state and it is then judged that the low-efficiency power generation is allowed, the low-efficiency power generation is performed. When the low-efficiency power generation is performed, immediate warm-up can be realized, and the cathode water balance of a fuel cell 2 can be brought into a plus (wet) state, the water condition and temperature of the fuel cell can be quickly and optimally controlled as compared with a conventional technology in which laborious processing such as FC temperature lowering processing→warm-up processing has been required.

Here, the above constitution preferably further includes a cooling mechanism which cools the fuel cell in a case where it is judged that the low-efficiency power generation is not allowed.

Moreover, in the above constitution, the first judgment means preferably further includes impedance measurement means for measuring the impedance of the fuel cell, and judges whether or not the fuel cell is in the dry state based on the measurement result of the impedance.

Furthermore, in the above constitution, the second judgment means preferably further includes concerned temperature measurement means for measuring a temperature concerned with the fuel cell, and judges whether or not to allow the low-efficiency power generation based on the measurement result of the concerned temperature.

Additionally, the above constitution preferably further includes an accumulator which charges or discharges a power, and the second judgment means further includes detection means for detecting the state of charge in the accumulator, and judges whether or not to allow the low-efficiency power generation based on the measurement result of the concerned temperature and the detection result of the state of the charge.

Furthermore, in the above constitution, the detection means preferably detects an SOC value or a charge power of the accumulator, and the second judgment means judges whether or not to allow the low-efficiency power generation based on the measurement result of the concerned temperature and the detection result of the SOC value or the charge power of the accumulator.

### Effect of the Invention

As described above, according to the present invention, even when the fuel cell is at a low temperature and the fuel cell is in a dry state, the water condition and temperature of the fuel cell can be quickly and optimally controlled.

### Best Mode for Carrying out the Invention

Hereinafter, a preferable embodiment of the present invention will be described with reference to the accompanying drawings. First, an outline of a fuel cell system of the present invention will be described.

### A. First Embodiment

FIG. 1 is a constitution diagram of a fuel cell system 1 according to a first embodiment.

The fuel cell system 1 can be mounted in a vehicle 100 such as a fuel cell hybrid vehicle (FCHV), an electric car or a hybrid car. However, the fuel cell system 1 is applicable even to various mobile bodies (e.g., a ship, an airplane, a robot or the like) other than a vehicle 100, a stational power source, or a portable fuel cell system.

The fuel cell system 1 includes a fuel cell 2, an oxidizing gas piping system 3 which supplies air as an oxidizing gas to the fuel cell 2, a fuel gas piping system 4 which supplies a hydrogen gas as a fuel gas to the fuel cell 2, a refrigerant piping system 5 which supplies a refrigerant to the fuel cell 2, a power system 6 which charges or discharges a power of the system 1, and a control device 7 which generally controls the operation of the system 1. The oxidizing gas and fuel gas can generically be referred to as a reactant gas.

The fuel cell 2 is of, for example, a solid polymer electrolyte type, and has a stack structure in which a large number of unitary cells are stacked. In each unitary cell, a solid polymer membrane having a proton conductivity is applied to an electrolyte layer, and the cell has an air pole (a cathode) on one face of an electrolyte, a fuel pole (an anode) on the other face thereof, and a pair of separators which sandwich the air pole and the fuel pole from both sides. The oxidizing gas is supplied to an oxidizing gas passage 2a of one of the separators, and the fuel gas is supplied to a fuel gas passage 2b of the other separator. The fuel cell 2 generates a power by an electrochemical reaction between the supplied fuel gas and oxidizing gas.

The oxidizing gas piping system 3 has a supply path 11 through which the oxidizing gas to be supplied to the fuel cell 2 flows, and a discharge path 12 through which an oxidizing off gas discharged from the fuel cell 2 flows. The supply path 11 communicates with the discharge path 12 via the oxidizing gas passage 2a. The oxidizing off gas includes water generated by the cell reaction of the fuel cell 2, and hence has a highly wet state.

The supply path 11 is provided with a compressor 14 which takes outside air through an air cleaner 13, and a humidifier 15 which humidifies the oxidizing gas forwarded to the fuel cell 2 under pressure by the compressor 14. The humidifier 15 performs water exchange between the oxidizing gas flowing through the supply path 11 and having a lowly wet state and the oxidizing off gas flowing through the discharge path 12 and having the highly wet state, and appropriately humidifies the oxidizing gas to be supplied to the fuel cell 2.

The back pressure of the fuel cell 2 on the side of the air pole is regulated by a back pressure regulation valve 16 provided in the discharge path 12 near a cathode outlet. A pressure sensor P1 which detects the pressure in the discharge path 12 is provided in the vicinity of the back pressure regulation valve 16. The oxidizing off gas is finally discharged as an exhaust gas to the atmosphere outside the system through the back pressure regulation valve 16 and the humidifier 15.

The fuel gas piping system 4 has a hydrogen supply source 21; a supply path 22 through which the hydrogen gas to be supplied from the hydrogen supply source 21 to the fuel cell 2 flows; a circulation path 23 which returns a hydrogen off gas (the fuel off gas) discharged from the fuel cell 2 to a joining part A of the supply path 22; a pump 24 which forwards the hydrogen off gas in the circulation path 23 under pressure to the supply path 22; and a purge path 25 branched and connected to the circulation path 23. The hydrogen gas discharged from the hydrogen supply source 21 to the supply path 22 by opening an original valve 26 is supplied to the fuel cell 2 through a pressure regulation valve 27, another pressure reduction valve and a block valve 28. The purge path 25 is provided with a purge valve 33 for discharging the hydrogen off gas to a hydrogen diluter (not shown).

The refrigerant piping system (a cooling mechanism) 5 has a refrigerant passage 41 which communicates with a cooling passage 2c in the fuel cell 2; a cooling pump 42 provided in the refrigerant passage 41; a radiator 43 which cools a refrigerant discharged from the fuel cell 2; a bypass passage 44 which bypasses the radiator 43; and a switch valve 45 which sets the passing of cooling water through the radiator 43 and the bypass passage 44. The refrigerant passage 41 has a temperature sensor 46 provided in the vicinity of a refrigerant inlet of the fuel cell 2, and a temperature sensor 47 provided in the vicinity of a refrigerant outlet of the fuel cell 2. A refrigerant temperature (the concerned temperature of the fuel cell) detected by the temperature sensor 47 reflects the internal temperature of the fuel cell 2 (hereinafter referred to as the FC temperature). It is to be noted that the temperature sensor 47 may detect may detect a component temperature around the fuel cell (the concerned temperature of the fuel cell) or the outside air temperature (the concerned temperature of the fuel cell) around the fuel cell instead of (or in addition to) the refrigerant temperature. Moreover, the cooling pump 42 of the fuel cell is driven by a motor to circulate and supply the refrigerant through the refrigerant passage 41 to the fuel cell 2.

The power system 6 includes a high pressure DC/DC converter 61, a battery 62, a traction inverter 63, a traction motor 64 and various auxiliary device inverters 65, 66 and 67. The high pressure DC/DC converter 61 is a direct-current voltage converter, and has a function of regulating a direct-current voltage input from the battery 62 to output the voltage to a traction inverter 63 side and a function of regulating a direct-current voltage input from the fuel cell 2 or the traction motor 64 to output the voltage to the battery 62. The charging/discharging of the battery 62 is realized by these functions of the high pressure DC/DC converter 61. Moreover, the output voltage of the fuel cell 2 is controlled by the high pressure DC/DC converter 61.

The battery (the accumulator) 62 is a chargeable/dischargeable secondary cell, and is, for example, a nickel hydrogen battery or the like. Alternatively, various types of secondary cells are applicable. Moreover, instead of the battery 62, a chargeable/dischargeable accumulator other than the secondary cell, for example, a capacitor may be used.

The traction inverter 63 converts a direct current into a three-phase alternate current to supply the current to the traction motor 64. The traction motor 64 is, for example, a three-phase alternate current motor. The traction motor 64 is, for example, a main power source of the vehicle 100 in which the fuel cell system 1 is mounted, and is connected to wheels 101L, 101R of the vehicle 100. The auxiliary device inverters 65, 66 and 67 controls the driving of motors of the compressor 14, the pump 24 and the cooling pump 42, respectively.

A control device 7 is a microcomputer including a CPU, an ROM and an RAM therein. The CPU executes desired computation in accordance with a control program, and performs various types of processing and control such as the control of a usual operation and the control of a warm-up operation. The ROM stores a control program and control data to be processed by the CPU. The RAM is mainly used as various operation regions for control processing.

A timer 70, a voltage sensor 72 and a current sensor 73 are connected to the control device 7. The timer 70 measures various types of time necessary for controlling the operation of the fuel cell system 1. The voltage sensor 72 detects the output voltage (the FC voltage) of the fuel cell 2. Specifically, the voltage sensor 72 detects the voltage (hereinafter referred to as “the cell voltage”) generated each of a large number of unitary cells of the fuel cell 2. In consequence, the state of each unitary cell of the fuel cell 2 is grasped. The current sensor 73 detects the output current (the FC current) of the fuel cell 2.

The control device 7 inputs detection signals from various sensors such as the pressure sensor P1, the temperature sensors 46, 47 and an accelerator open degree sensor for detecting the open degree of an accelerator of the vehicle 100, and outputs control signals to constituent elements (the compressor 14, the back pressure regulation valve 16, etc.).

Moreover, the control device 7 performs the diagnosis of the water condition of the fuel cell 2 at a predetermined timing or the like, and controls the water of the fuel cell 2 based on a diagnosis result. Details will be described later, but the present embodiment is characterized in that in a case where it is judged that the fuel cell 2 is in the dry state and it is judged that the fuel cell 2 is at the low temperature, the low-efficiency power generation is performed to realize both the appropriate temperature control and the appropriate water control of the fuel cell 2.

Thus, in the present embodiment, one processing of the low-efficiency power generation can realize the optimization of the water condition and the optimization of FC temperature in the fuel cell 2. Therefore, as compared with a conventional technology in which a laborious procedure of the FC temperature lowering processing→warm-up processing is necessary, the processing can be speeded up. Heretofore, a difference between the low-efficiency power generation and usual power generation will be described.

<Difference Between Low-Efficiency Power Generation and Usual Power Generation>

FIG. 2 is a diagram showing a relation between the output current (the FC current) and the output voltage (the FC voltage) of the fuel cell. A solid line shows a case where usual power generation is performed, and a dotted line shows a case where the low-efficiency power generation is performed. It is to be noted that the abscissa indicates the FC current, and the ordinate indicates the FC voltage.

Here, the low-efficiency power generation is power generation in which the amount of the reactant gas (the oxidizing gas in the present embodiment) to be supplied to the fuel cell 2 is small and a power loss is large as compared with the usual power generation, and the fuel cell 2 is operated in a state in which an air stoichiometric ratio is reduced to, for example, the vicinity of 1.0 (a theoretical value) (see the dotted line part of FIG. 2). When the power loss is set to such a large value, the fuel cell 2 can immediately be warmed up. On the other hand, during the usual power generation, to suppress the power loss and obtain a high power generation efficiency, a fuel cell 40 is operated while the air stoichiometric ratio is set to, for example, 2.0 or more (a theoretical value) (see the solid line part of FIG. 2).

FIG. 3 is a diagram illustrating a relation between the FC current and cathode water balance during the low-efficiency power generation and the usual power generation. A broken line shows the operation point of the low-efficiency power generation, and a solid line shows the operation point of the usual power generation. It is to be noted that as either of the operation point during the low-efficiency power generation and the operation point during the usual power generation shown in FIG. 3, there is assumed a case where the FC temperature is equal (e.g., 70° C.).

As described above, the air stoichiometric ratio during the usual power generation is 2.0 or more, whereas the air stoichiometric ratio set during the low-efficiency power generation is around 1.0. Therefore, the amount of the water included in the oxidizing off gas and discharged externally form the system decreases. An example shown in FIG. 3 will be described. When the FC temperature is equal and the FC current is equal, the cathode water balance during the low-efficiency power generation becomes larger than that during the usual power generation (see operation points α1, α2). As shown in FIG. 3, when the operation point α1 (the usual power generation) shifts to the operation point α2 (the low-efficiency power generation), the cathode water balance moves from a dry side to a wet side.

As apparent from the above, when the low-efficiency power generation is performed, the immediate warm-up of the fuel cell 2 can be realized, and the cathode water balance of the fuel cell 2 can be brought into a plus (wet) state. Therefore, even in a case where it is judged that the fuel cell 2 is in the dry state and that the fuel cell 2 is at the low temperature, the low-efficiency power generation can be performed to quickly and optimally control the water condition of the fuel cell 2 and the temperature of the fuel cell 2. Heretofore, the water control processing of the fuel cell 2 will be described.

FIG. 4 is a flow chart showing the water control processing of the fuel cell 2 executed by the control device 7.

First, in step S110, the control device 7 judges whether or not a timing (hereinafter referred to as the diagnosis timing) to diagnose the water condition of the fuel cell 2 is reached. It is to be noted that in the following example, as a diagnosis timing, a system startup time is assumed, but the timing during a system operation, a system stop, an intermittent operation or the like may arbitrarily be set or changed in accordance with system design or the like.

In a case where it is judged that the diagnosis timing is not reached (the step S110; NO), the control device 7 ends the processing without executing the following steps. On the other hand, in a case where the control device 7 detects that the startup command of the fuel cell system has been input by, for example, the ON operation of an ignition switch by a driver of the vehicle 100 or the like, the control device judges that the diagnosis timing is reached (the step S110; YES), thereby advancing to step S120.

When the control device (first judgment means) 7 advances to the step S120, the control device measures the impedance of the fuel cell 2, diagnoses the water condition of the fuel cell 2 based on the measurement result, and judges whether or not the fuel cell 2 is in the dry state. This will be described in detail. First, the control device (impedance measurement means) 7 samples the FC voltage detected by the voltage sensor 72 and the FC current detected by the current sensor 73 at a predetermined sampling rate, and performs Fourier transform processing (FET computation processing or DFT computation processing) or the like. Moreover, the control device (the impedance measurement means) 7 measures the impedance of the fuel cell 2 by dividing a FC voltage signal subjected to the Fourier transform processing by an FC current signal subjected to the Fourier transform processing or the like.

Then, the control device 7 reads a reference impedance IPth stored in a reference impedance memory 92, and compares the read reference impedance IPth with a measured. impedance (hereinafter referred to as the measured impedance).

Here, the reference impedance IPth is a reference value for judging whether or not the fuel cell 2 is in the dry state, and obtained by an experiment or the like in advance. Specifically, the impedance for judging whether or not the fuel cell 2 is in the dry state is obtained by the experiment or the like, mapped and stored in the reference impedance memory 92.

In a case where the measured impedance is below the reference impedance IPth and the control device 7 judges that the fuel cell 2 is not dry (in other words, the fuel cell 2 is in a wet state), the control device ends the processing without executing the following steps). On the other hand, in a case where the measured impedance is the reference impedance IPth or more and the control device (second judgment means) 7 judges that the fuel cell 2 is in the dry state, the processing advances to step S130 to judge whether or not to allow the low-efficiency power generation.

This step will be described in detail. The control device 7 compares the FC temperature (hereinafter referred to as the detected FC temperature) detected by the temperature sensor 47 with a reference FC temperature stored in a reference FC temperature memory 91, and judges whether or not to allow the low-efficiency power generation. Here, a reference FC temperature Tth is a reference value (e.g., 70° C.) for judging whether or not to allow the low-efficiency power generation of the fuel cell 2, and obtained by an experiment or the like in advance. Specifically, the FC temperature for judging whether or not to allow the low-efficiency power generation is obtained by the experiment or the like, mapped and stored in the reference FC temperature memory 91.

In a case where the detected FC temperature exceeds the reference FC temperature Tth and the control device 7 judges that the low-efficiency power generation is not allowed (is inhibited in other words), the control device advances to step S150 to perform FC temperature lowering processing, thereby ending the processing. Specifically, the control device controls the driving of a cooling mechanism such as the cooling pump 42 or the radiator 43 to perform processing for lowering the FC temperature to an allowable temperature set to the control device 7 or the like to bring the water of the fuel cell 2 into an optimum state, thereby ending the processing.

On the other hand, in a case where the detected FC temperature is the reference FC temperature Tth or less and the control device (power generation control means) 7 judges that the low-efficiency power generation is allowed, the control device advances to step S140 to perform the low-efficiency power generation, thereby ending the processing. As described above with reference to FIG. 3, when the low-efficiency power generation is performed, the immediate warm-up of the fuel cell 2 can be realized, and the cathode water balance of the fuel cell 2 can be brought into the plus (wet) state. Consequently, even in a case where it is judged that the fuel cell 2 is in the dry state (the step S120; YES) and that the fuel cell 2 is at the low temperature (the step S130; YES), the low-efficiency power generation can be performed to quickly and optimally control the water condition of the fuel cell 2 and the temperature of the fuel cell 2.

As described above, according to the present embodiment, even in a case where it is judged that the fuel cell 2 is in the dry state and that the fuel cell 2 is at the low temperature, the low-efficiency power generation can be performed to quickly and optimally control the water condition of the fuel cell 2 and the temperature of the fuel cell 2.

### B. Second Embodiment

In the above first embodiment, it is judged whether or not to allow low-efficiency power generation only based on a detected FC temperature, but additionally it may be judged whether or not to allow the low-efficiency power generation based on the state of the charge of a battery (an accumulator) 62. FIG. 5 is a diagram showing a constitution of a fuel cell system 1′ according to a second embodiment. It is to be noted that parts corresponding to those of FIG. 1 are denoted with the same reference numbers, and the detailed description thereof is omitted.

An SOC sensor (detection means) 74 detects the SOC value of the battery 62 (the state of the charge of the battery 62), and informs a control device 7 of the value as the detected SOC value.

A reference SOC memory 93 stores a reference SOC value (e.g., 75%) for judging whether or not a fuel cell 2 allows the low-efficiency power generation. A reference SOC value Sth is obtained by an experiment or the like in advance. Specifically, the reference SOC value Sth for judging whether or not to allow the low-efficiency power generation is obtained by the experiment or the like, mapped and stored in the reference SOC memory 93.

The control device (second judgment means) 7 judges whether or not to allow the low-efficiency power generation based on an FC temperature and an SOC value. This will be described in detail. When the detected FC temperature is the reference FC temperature Tth or less and the detected SOC value is the reference SOC value Sth or less, the control device 7 judges that the low-efficiency power generation is allowed. In another case, the control device judges that the low-efficiency power generation should be inhibited. Thus, it is judged whether or not to allow the low-efficiency power generation based on not only the FC temperature but also the state of the charge of the battery 62, whereby overcharge from the fuel cell 2 to the battery 62 by the low-efficiency power generation can be prevented in advance.

It is to be noted that in the above example, the state of the charge of the battery 62 is detected by the SOC value, but the state of the charge of the battery 62 may be detected based on a battery charge power instead of (in addition to) this value. Specifically, a battery charge power detection sensor 74′ is provided instead of the SOC sensor 74, and a reference battery charge allowable power memory 93′ is provided instead of the reference SOC memory 93.

The battery charge power detection sensor (detection means) 74′ detects the charge power of the battery 62 (the state of the charge of the battery 62), and notifies the control device 7 of the power as a detected charge power.

The reference battery charge allowable power memory 93′ stores a reference battery charge allowable power (e.g., 2.5 kW) for judging whether or not the fuel cell 2 allows the low-efficiency power generation. A reference battery charge allowable power Wth is obtained by an experiment or the like in advance. Specifically, the reference battery charge allowable power Wth for judging whether or not to allow the low-efficiency power generation is obtained by the experiment or the like, mapped and stored in the reference battery charge allowable power memory 93′.

The control device (the second judgment means) 7 judges whether or not to allow the low-efficiency power generation based on the FC temperature and the detected charge power. This will be described in detail. When the detected FC temperature is the reference FC temperature Tth or less and the detected charge power is the reference battery charge allowable power Wth or less, the control device 7 judges that the low-efficiency power generation is allowed. In another case, the control device judges that the low-efficiency power generation should be inhibited. Even according to such a constitution, overcharge from the fuel cell 2 to the battery 62 by the low-efficiency power generation can be prevented in advance. It is to be noted that in the embodiments, as the reactant gas whose supply amount is reduced during the low-efficiency power generation, an oxidizing gas to be supplied to a cathode is illustrated, but needless to say, the amount of a fuel gas to be supplied to an anode or the amounts of both the reactant gases may be reduced.

### BRIEF DESCRIPTION OF THE DRAWINGS

FIG. 1 is a constitution diagram of a fuel cell system according to a first embodiment;

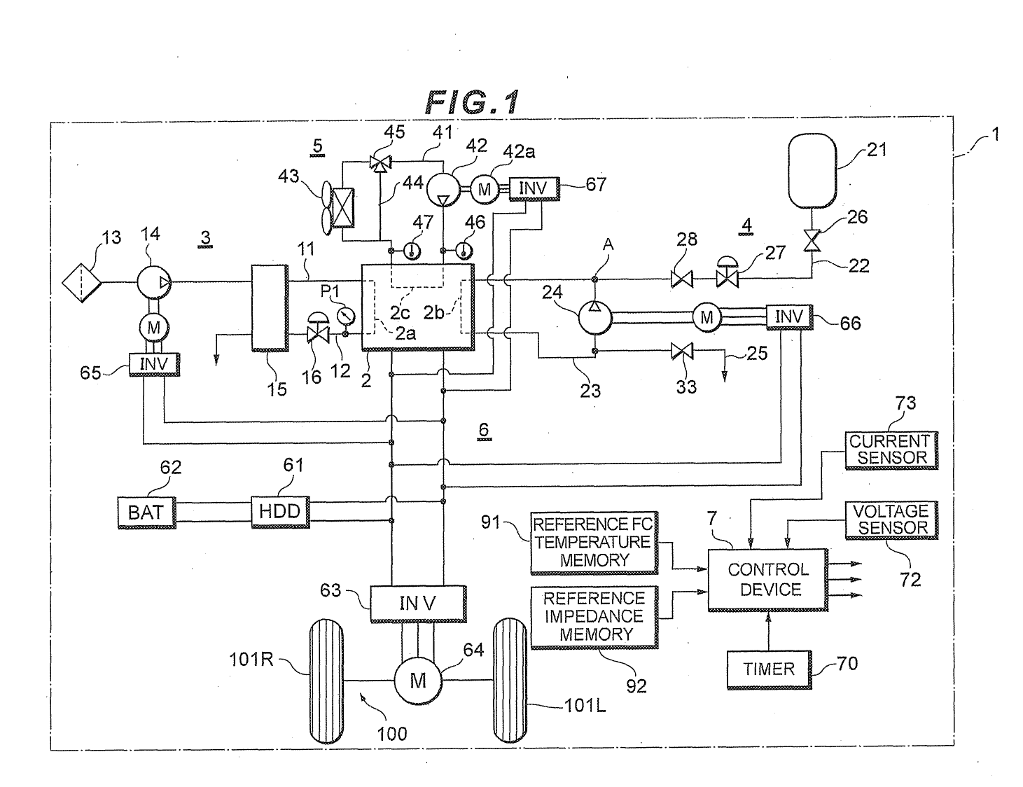

FIG. 2 is a diagram showing a relation between an FC current and an FC voltage according to the embodiment;

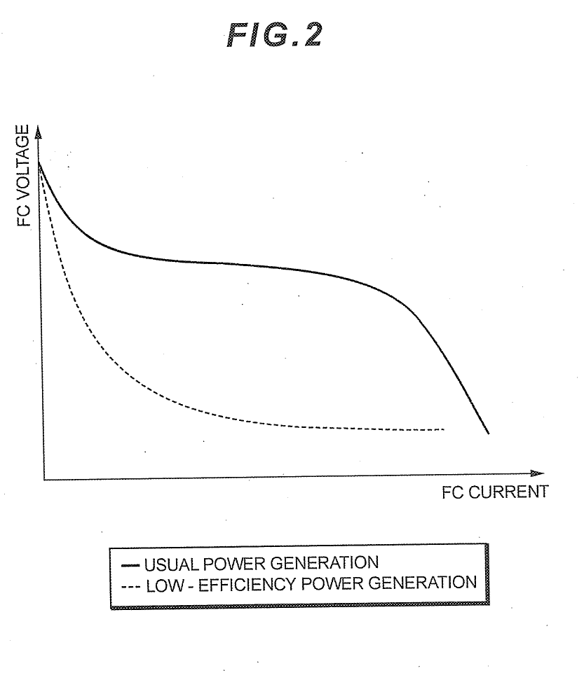

FIG. 3 is a diagram showing a relation between the FC current and a cathode water balance according to the embodiment;

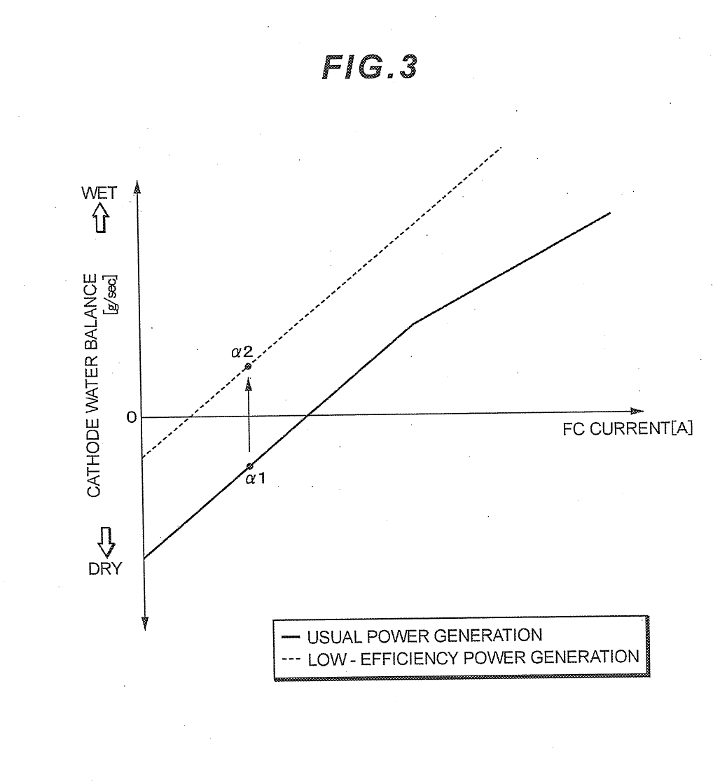

FIG. 4 is a flow chart showing water control processing according to the embodiment; and

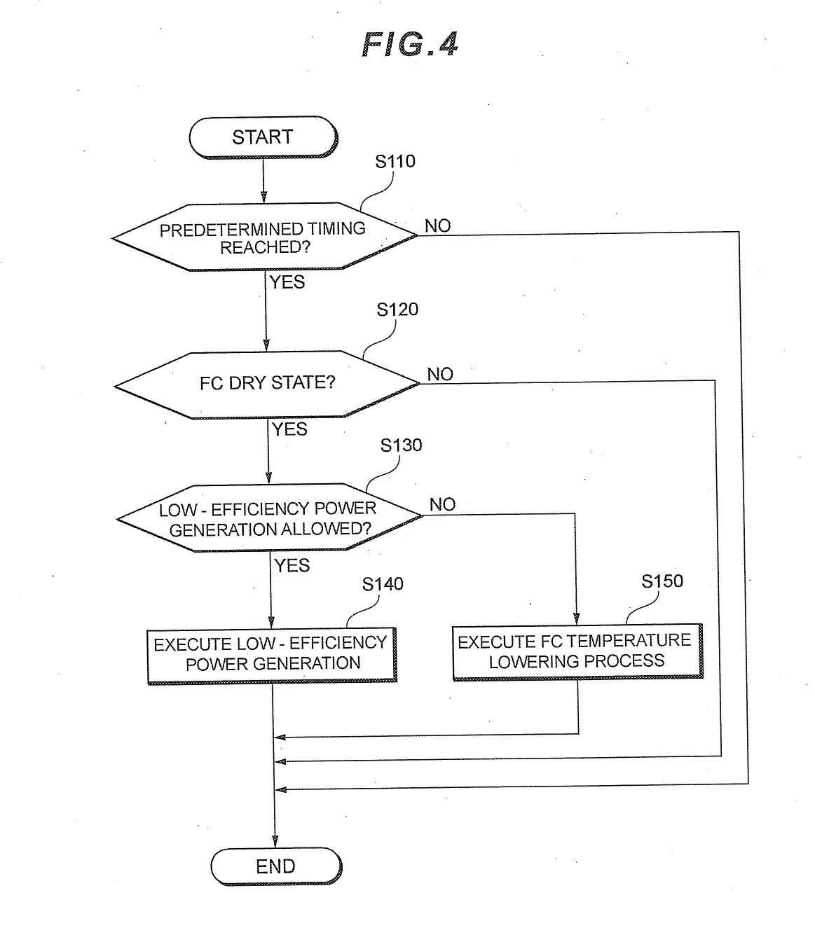

FIG. 5 is a constitution diagram of a fuel cell system according to a second embodiment.

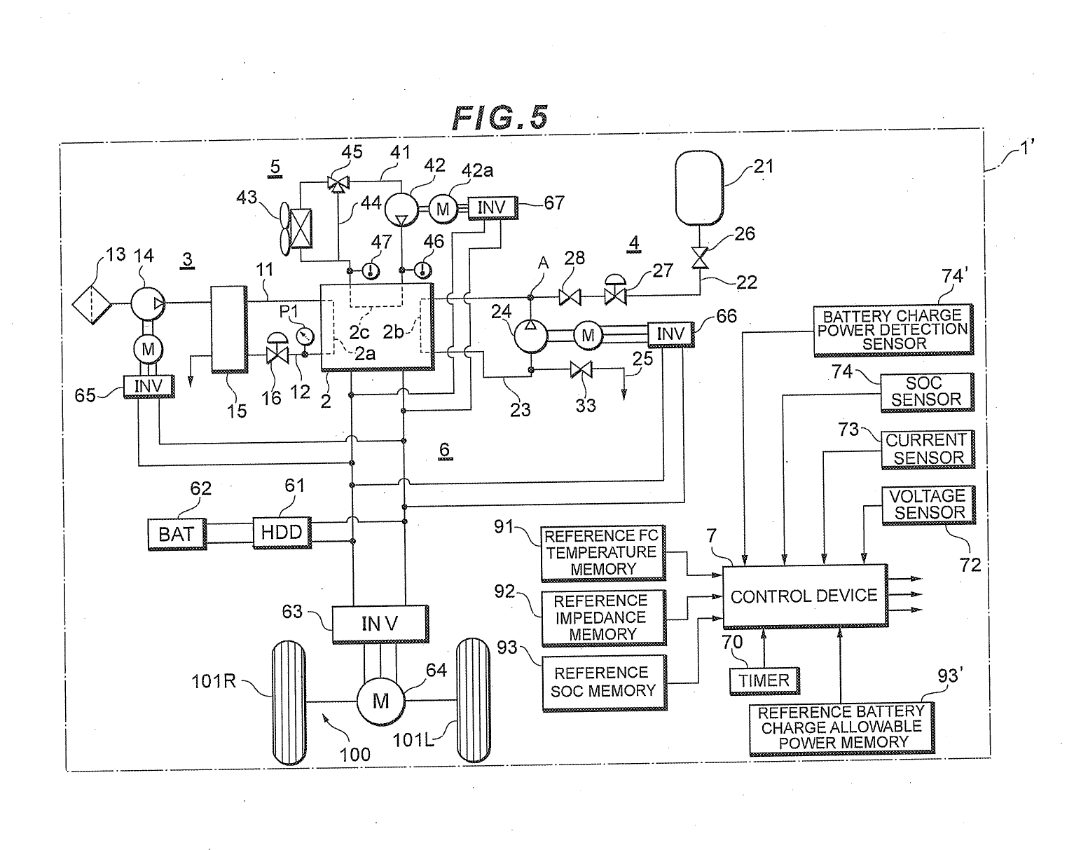

### DESCRIPTION OF REFERENCE NUMERALS

1, 1′ . . . fuel cell system, 2 . . . fuel cell, 7 . . . control device, 42 . . . cooling pump, 43 . . . radiator, 47 . . . temperature sensor, 70 . . . timer, 72 . . . voltage sensor, 73 . . . current sensor, 74 . . . SOC sensor, 74′ . . . battery charge power detection sensor, 91 . . . reference FC temperature memory, 92 . . . reference impedance memory, 93 . . . reference SOC memory, and 93′ . . . reference battery charge allowable power memory.

1. A fuel cell system including:
a first judgment device that judges whether or not a fuel cell is in a dry state;
a second judgment device that judges whether or not to allow low-efficiency power generation in which the amount of a reactant gas to be supplied to the fuel cell is small as compared with usual power generation and in which a power loss is large as compared with the usual power generation, in a case where it is judged that the fuel cell is in the dry state; and
a power generation control device that executes the low-efficiency power generation in a case where it is judged that the low-efficiency power generation is allowed.

2. The fuel cell system according to claim 1, further including:
a cooling mechanism which cools the fuel cell in a case where it is judged that the low-efficiency power generation is not allowed.

3. The fuel cell system according to claim 1, wherein the first judgment device further includes an impedance measurement device that measures the impedance of the fuel cell, and judges whether or not the fuel cell is in the dry state based on the measurement result of the impedance.

4. The fuel cell system according to claim 2, wherein the second judgment device further includes a concerned temperature measurement device that measures a temperature concerned with the fuel cell, and judges whether or not to allow the low-efficiency power generation based on the measurement result of the concerned temperature.

5. The fuel cell system according to claim 4, further including:
an accumulator which charges or discharges a power, and
the second judgment device further includes a detection device that detects the state of charge in the accumulator, and judges whether or not to allow the low-efficiency power generation based on the measurement result of the concerned temperature and the detection result of the state of the charge.

6. The fuel cell system according to claim 5, wherein the detection device detects an SOC value or a charge power of the accumulator, and
the second judgment device judges whether or not to allow the low-efficiency power generation based on the measurement result of the concerned temperature and the detection result of the SOC value or the charge power of the accumulator.
